(19) United States
(12) Patent Application Publication
(10) Pub. No.: US 2024/0403696 A1
(43) Pub. Date: Dec. 5, 2024

(54) Alethiometer Gamification for Teaching Artificial Intelligence Trustworthiness

(71) Applicant: Tony Tateossian, Glendale, CA (US)

(72) Inventor: Tony Tateossian, Glendale, CA (US)

(21) Appl. No.: 18/204,992

(22) Filed: Jun. 2, 2023

(51) Int. Cl. G06N 20/00

(52) U.S. Cl. CPC G06N 20/00

(57) ABSTRACT

The present disclosure is known as the ‘alethiometer trustworthiness system’ (ATS). The system is comprised of a gamification application (app) and a method of determining trustworthiness behavior in response to verbal queries in real time as part of an entertaining game. The system examines a plurality of biometric responses (such as eye movements, voice pitch changes, micro expressions etc.) and quickly compares said responses to common responses acquired to a vast response database on a cloud network. The system utilizes artificial intelligence algorithms (AI) and computes a trustworthiness score (TWS) to a query event within the game. An object of the system is to provide a means of entertainment while at the same time teaching AI the biometric and behavioral responses to recognize and predict trustworthiness accurately.

### FIELD OF THE INVENTION

The present invention generally relates to gamification. More specifically, it relates to a system and method of teaching AI the biometric and behavioral responses to recognize and predict trustworthiness accurately through gamification.

### BACKGROUND

Early lie detection methods can be traced back to the Middle Ages and mainly involved some form of cruel torture. In the late 1800s Cesare Lombroso measured changes in blood pressure during police interrogations. In 1904 a device by Vittorio Benussi measured breathing rates during questioning. A man named Mackenzie-Lewis developed the first Polygraph in 1906 which used blood pressure to examine responses of German prisoners of war and the machine indicated a strong positive correlation between systolic blood pressure and lying. Another device that recorded both blood pressure and breathing was invented in 1921 by John Augustus Larson of the University of California and was first applied in law enforcement work by the Berkeley Police Department. Further work on this device was done by Leonarde Keeler who and added the galvanic skin response to it in 1939. His device was then purchased by the FBI, and served as the prototype of the modern polygraph. Since this time, lie detection has started using various computer technologies to enhance its capabilities. United States Patent No. U.S. Pat. No. 8,571,629B2 granted to Faro et. al. disclosed a method of utilizing MRI scans to detect deception. United States Patent No. U.S. Pat. No. 8,543,196B2 granted to Ning disclosed a lie detection system based on heart rate variability. Chinese Patent No. CN109793526 disclosed a lie detection method based on micro facial expressions. What is needed is a comprehensive method of aiding in truth detection based on AI and gamification best practices.

### SUMMARY OF THE INVENTION

The device herein disclosed and described provides a solution to the shortcomings in the prior art through the disclosure of a system and method for teaching AI how to recognize and predict trustworthiness from respondent biometrics, responses and behavior through the use of gamification. The app is predicated upon a game wherein users ask others to participate with existing mobile devices (smartphone etc.). Once a respondent agrees, the user reads questions from the app and the records the respondent answering the questions and the app assigns a TWS to answers as part of the game. When the correct answers are revealed in the game, they are sent to the AI's learning database (along with other respondent answers) and are used to teach the AI how to further recognize trustworthiness over time. In some embodiments, multiple participants can play remotely and vote on answers within the game.

The device herein disclosed and described provides a solution to the shortcomings in the prior art through the disclosure of a system and method of determining trustworthiness behavior of a user in response to verbal queries in real time. The ATS provides a TWS that becomes an important factor as part of an overall plan when making deception determinations in the game.

Another object of the invention is to provide a means for users to determine trustworthiness of responses of individuals anywhere and at any time. The software runs on any mobile computing device and users no longer need to be inside an office sitting in a chair with wires attached to them.

Another object of the invention is to allow users to collect a wide array of biometric data from respondents. Such data can include eye movements, speech patterns, body movements, and vital signs etc.

Another object of the invention is to allow users to pick and choose what biometrics will be gathered from an individual during the game. For example, they may prefer to gather facial data in combination with body movements from one respondent and vital sign data and body temperature data from another respondent.

Another object of the invention is to provide a reliable means of interpreting biometric data. Once the data is collected, it is immediately transferred to a cloud network that contains various AI algorithms. The AI quickly compares the combinations of respondent biometric data with an existing digital library of thousands respondent biometric data. The AI then calculates the TWS score as a means of predicting trust worthiness of the line of questioning event and said score is sent back to the user in the game. A low TWS score suggests a response may be considered untrustworthy or that an attempt at deception has taken place. A high TWS score suggests a response may be genuine or truthful. This predictive measure provides the user with additional information when making decisions during line of questioning events.

Another object of the invention is to provide an alternative means of collecting additional biometric response data for expanding the AI library. The app includes a gamification feature that allows users to participate by responding to pre-determined questions as a fun and entertaining activity. The biometric responses are then collected and added to the AI database to increase reliability. Other embodiments of the ATS account for differences in response data based on cultural, behavioral differences. When biometric data is gathered, users are asked questions regarding their ethnicity and the data is classified according to their responses. Therefore, confounding variables can be held constant when a TWS is computed. For example, eye movement data can be held constant for those from Asian countries who tend to value a lack of eye movement more often than western cultures during social interactions.

Another object of the invention is to allow for continuous improvement in TWS reliability. As more and more biometric data is collected (anonymously from the game over time), the ability of the AI to make stronger TWS predictions also increases. When a line of questioning event takes place, a TWS is provided along with a confidence interval (CI) for said score based on correlational response and gamification data collected for predictions over time—for example TWS=90/CI=65%-85%.

Another object of the invention is to provide ‘pre-survey question guidance’ to users who are assembling a line of questioning for a respondent in a game. Users generate a draft of questions and send it to the cloud network. AI algorithms scan the questions for key words and then classify and select questions according to how reliable they have performed in the past (high CI percentages). The questions having highest CIs are then recommended to the user.

Another object of the invention is to provide a means of enhancing low TWS and high CI scores during a line of questioning event using a ‘post-pick and replace’ feature during the game. This feature allows users to pick from a range of related lines of questioning that users can choose from to replace existing questions with low CI scores with those that have had higher CI scores with respondents in the past.

Another object of the invention is to provide a ‘results dash board’ whereby users can view TWS and CI scores of an entire respondent survey along with a breakdown of TWS and CI scores for each question in the game real time. Such information is also reported graphically. This graphic feature can also help guide a user to continue a line of questioning event with specific follow up questions. For example, an investigator finds low TWS and high CI scores on questions that relate to a respondent's alibi during a deposition. They then expand the line of questioning to include further details about the alibi to strengthen their case against the respondent in real time.

Another object of the invention is to provide a ‘suppression score’ (SS). A sudden or abrupt shift in TWS from low to high may indicate that a respondent has recognized that they may be sending signals that could be interpreted as untrustworthy and attempt to suppress them. A high SS suggests suppression is taking place while a low score suggests no suppression. For example, a user starts fidgeting during a specific question and then abruptly stops—such an event then triggers a high suppression score.

Another object of the invention is to allow users to customize all biometric thresholds, herein referred to as ‘biometric threshold settings.’ Each biometric data class contains high and low thresholds that contribute to the overall TWS as well as individual CI and SS. For example, a user can set pupil dilation changes outside the range of between 4 mm-8 mm to be a contributing factor to a low TWS.

Another object of the invention is to provide an ‘ambient condition score’ (ACS). An ambient condition score relates to how close ambient conditions are as compared to an ideal condition. An ideal ambient condition is one that has been shown to cause the least amount of bias or provides the least number of confounding variables during a line of questioning event. For example, in order to obtain a high ACS, the following ambient conditions must be met: room lighting is set to 20 lumens per 250 square feet of room space; room air temperature is set at between 70-75 degrees fahrenheit and room air exchange rate is 0.35 air changes per hour. Holding the ACS constant can positively impact CIs because it can rule out reactions that may be due to environmental conditions rather than a respondent reaction to a sensitive question—for example, if a room is hot, the respondent's body temperature may elevate due to room conditions and not due to the line of questioning. Subsequently, deviations from the ACS can negatively-impact CIs.

Another object of the invention is to provide a means to adjust the weighting of the various biometric measurements before a final TWS is applied to a line of questioning event. In one of the previous examples given, a user could lower the weighting of the eye movement biometric value contribution of a respondent who is from an Asian country. The interface of the app allows for weighting of the various measurements to obtain the highest CIs to obtain the greatest accuracy and a sound TWS.

Another object of the invention is to allow users to share all TWS results with other stakeholders. The app is available on most mobile devices and data can be shared in real time between authorized parties.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows the ATS being used.

FIG. 1A shows embodiments of the various app screens.

FIG. 2 shows biometric data that is recorded.

FIG. 3 shows biometric data that is recorded.

FIG. 4 shows biometric data that is recorded.

FIG. 5 shows a representative view of the ATS process.

FIG. 6 shows a representative view of the ATS method.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

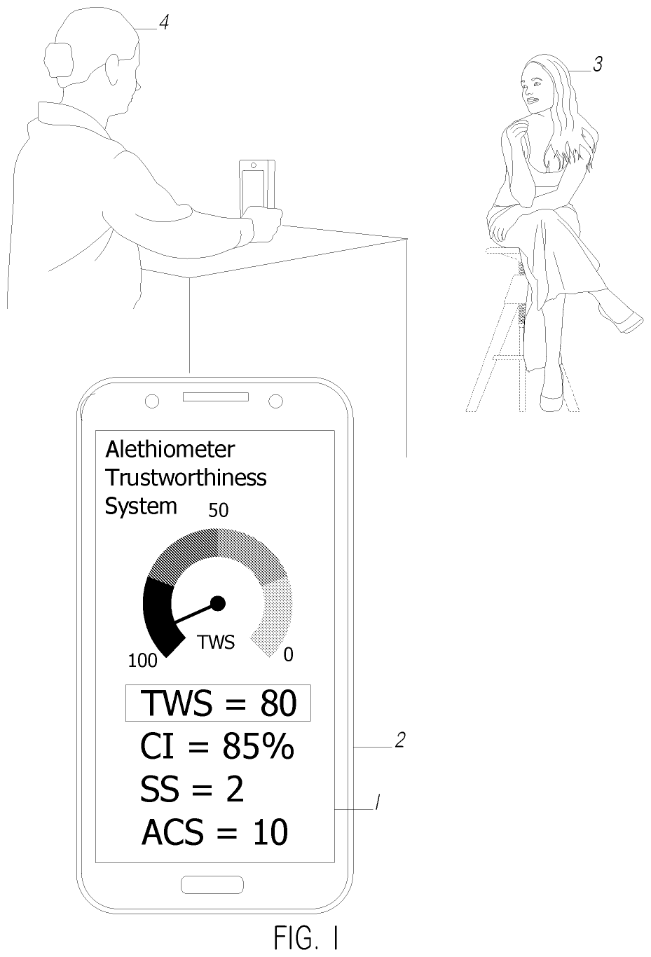

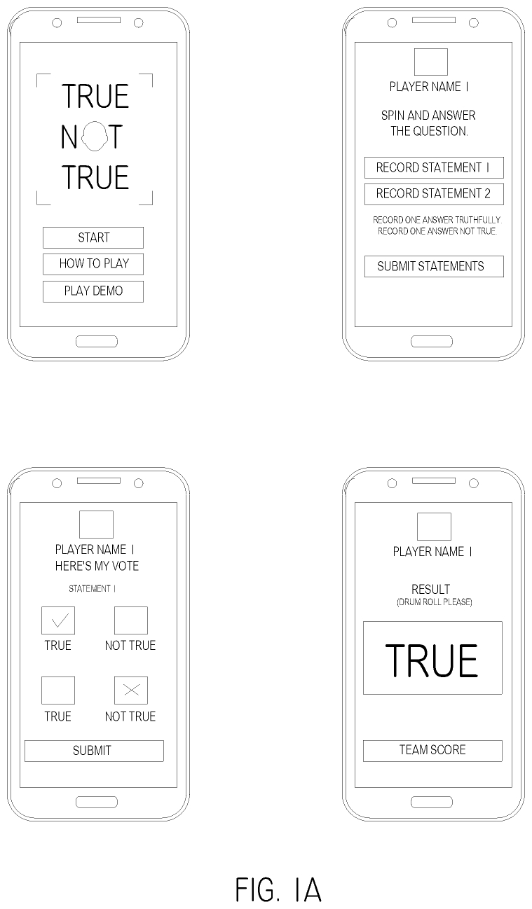

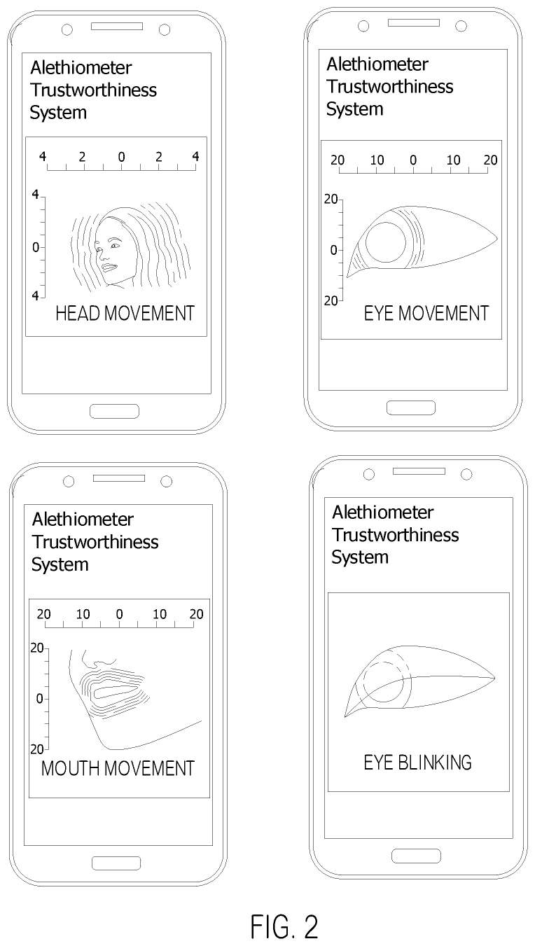

FIG. 1 shows a preferred embodiment of the ATS app 1 operating on mobile device 2 and being used by survey personnel to perform a line of questioning event on respondent 3. The ATS app 1 leveraging existing functions on the camera that include but are not limited to digital still camera, video camera, microphone, thermal imaging and the like. Several calibration images are taken of a respondent in a still position which are then averaged together and acts as a datum for all biometric data to be measured against. In addition, respondents are asked to read a pre-written sentence at least three times to develop a baseline speech pattern. The figure shows app 1's interface that summarizes biometric scores in real time including but not limited to: the TWS (in graphical gauge format); CI in percentage, SS score and ACS score. The higher the TWS, the more likely a line of questioning event is untrustworthy. FIG. 1A shows another embodiment of the various app screens in the game wherein other remote participants can play. FIGS. 2-4 show the various biometric elements such as but not limited to: head movement (HM); eye movement (EM); mouth movement (MM); eye blinking (EB); pupil dilation (PD); hand movement (HM); fidgeting level (FL); speech pitch (SP); facial heat mapping (FHM); speech speed (SSP); micro expressions (ME) and filler word frequency (FWF). FIG. 2 shows head movements that are detected by a mobile device's camera and the footage is translated onto the app 1's movement scales that detect amounts of both vertical and horizontal movements during a line of questioning event are compared against the calibrated datum images (herein referred to as ‘baseline’). Any movements that deviate at least more than 1% are then assigned a head movement score between 0-8.33.

FIG. 2 shows eye movements that are detected by a mobile device's camera and the footage is translated onto the app 1's movement scales that detect amounts of both vertical and horizontal movements during a line of questioning event are compared against the baseline. Any movements that deviate more than at least 3% are then assigned an eye movement score between 0-8.33. The figure shows mouth movements that are detected by a mobile device's camera and the footage is translated onto the app 1's movement scales that detect amounts of both vertical and horizontal movements during a line of questioning event are compared against the baseline. Any movements that deviate more than at least 5% are then assigned a mouth movement score between 0-8.33. Finally, the figure shows eye blinks that are detected by a mobile device's video camera and the footage is translated onto the app 1's frequency counter that detects the number of blinks and calculates a blink rate during a line of questioning event. Any blink rates that increase more than 10% are then assigned a blink rate score between 0-8.33.

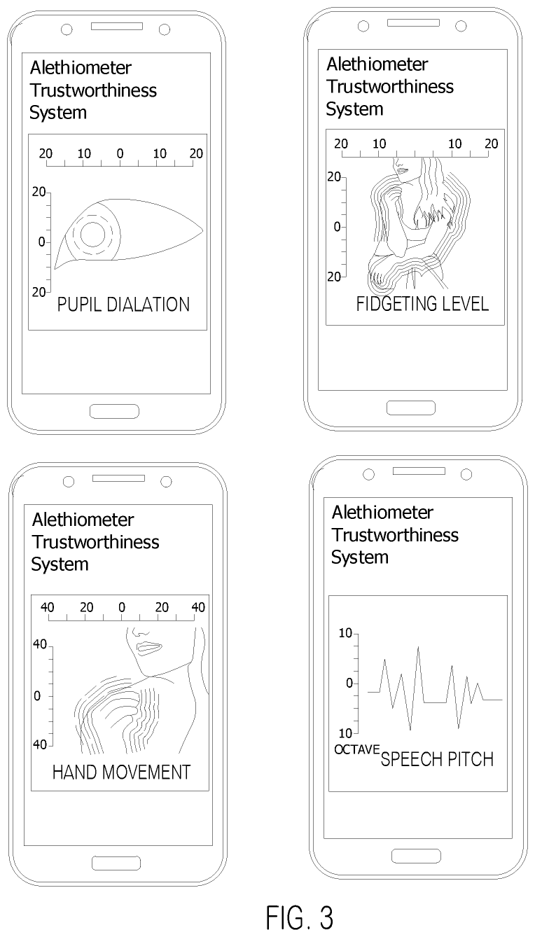

FIG. 3 shows pupil dilations that are detected by a mobile device's camera and the footage is translated onto the app 1's movement scales that detect amounts of both vertical and horizontal changes during a line of questioning event are compared against the baseline. Any pupils that increase in diameter in a range greater than 4%-8% are then assigned a pupil dilation score between 0-8.33. The figure shows the extent of fidgeting detected by a mobile device's camera and the footage is translated onto the app 1's movement scales that detect amounts of both vertical and horizontal fidgeting during a line of questioning event are compared against the baseline. Any significant fidgeting actions (at least twice over 6 inches) are then assigned a fidgeting score between 0-8.33. The figure shows hand movement rates that are detected by a mobile device's camera and the footage is translated onto the app 1's movement scales that detect amounts of both vertical and horizontal movements during a line of questioning event are compared against the baseline. Any hand movements that increase greater than 30% are then assigned a hand movement rate score between 0-8.33. The figure shows speech pitch that is detected by a mobile device's microphone and is translated onto the app 1's pitch scale that detect amounts of pitch change during a line of questioning event are compared against the baseline. Any pitch octave that increases at any point or at the end of a word greater than 9% are then assigned a speech pitch score between 0-8.33.

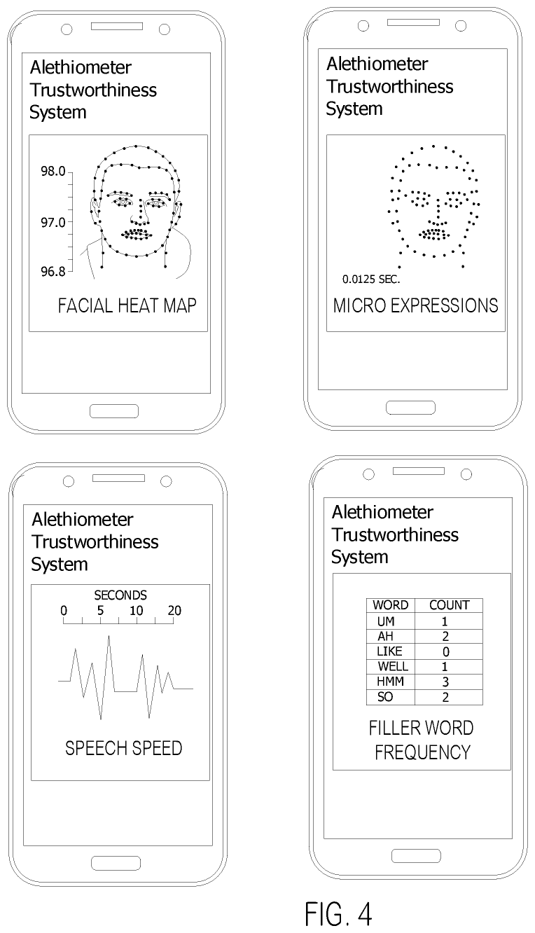

FIG. 4 shows facial heat mapping wherein thermal imaging cameras on mobile devices detect the temperatures of specific points on the face of a respondent—specifically around the eyes and periorbital regions (around the bridge of the nose and between the eyes). Any increases in temperature greater than 10% during a line of questioning event are assigned a score between 0-8.33%. The figure showing micro expressions wherein the video camera on mobile devices detect small movements of facial expressions that last greater than a range of between 1/25^{th}-⅕^{th} of a second are assigned a micro expression score between 0-8.33. The figure shows speech speed that is detected by a mobile device's microphone and the digital audio is translated onto the app 1's software during a line of questioning event is compared against the baseline. Any increases in speech speed that slows less than at least 40% of the baseline speed are then assigned a speech speed score between 0-8.33. Finally, the figure shows filler word frequency that is detected by a mobile device's microphones and is translated onto the app 1's frequency counter that detects the number of filler words used and calculates a filler word frequency during a line of questioning event. Any number of filler words used more than twice are then assigned a filler word score between 0-8.33.

All biometric elements introduced in FIGS. 2-4 are also assigned individual CI, SS and ACS scores and are then averaged for overall CI, SS and ACS scores for a line of questioning event. All biometric element scores are then aggregated to build an overall TWS for said event as shown in the formula:

TWS=HM+EM+MM+EB+PD+HM+FL+SP+FHM+SSP+ME+FWF

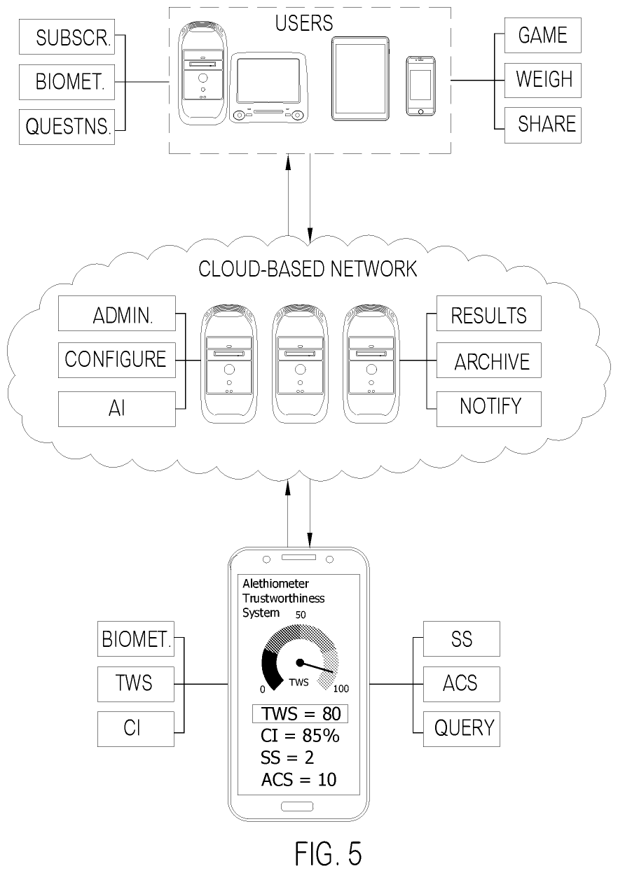

FIG. 5 shows a representative view of the ATS process wherein users having functions that include but are not limited to: selecting a subscription level; selecting biometric elements to be included in a line of questioning; assembling and building a line of questions; participating in a truthfulness game (gamification); weighting of the various biometric element scores, and sharing scores with stakeholders (via social media, text messages, email etc.). Users having the option of running the app on a plurality of computing devices including but not limited to: desktop computers, tablets, smart phones and the like. The user's mobile device running the ATS app and having operations that include but are not limited to: collecting biometric data (as mentioned above); displaying TWS, CI, SS and ACS scores and allowing users to query individual scores for each biometric element. Both users and computing devices being connected by a cloud-based network that has routines including but not limited to: administrative features (user demographics, payments, etc.); configurations (setting up calibration events, weighting biometrics etc.); AI (predicting appropriate questions for lines of questioning, computing TWS scores etc.); result operations (transmitting and displaying scores remotely); archives (collecting biometric elements from line of questioning and gamification events anonymously to build AI database); and notifications to stakeholders of scores etc.(email, SMS, text messages, and the like).

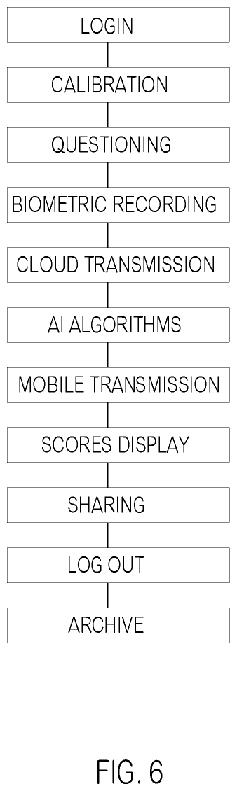

FIG. 6 shows a representative view of the ATS method which includes but is not limited to the following steps: user logging into the app; performing a line of questioning calibration (having respondent reading pre-determined questions while remaining still and recording all biometric elements as stated previously); initiating a line of questioning event; recording respondent's biometric elements onto a user's computing device; transmitting biometric elements to the cloud network; cloud network AI algorithms generating scores and comparing scores to database archives to make additional question recommendations and adding gamification response data to artificial intelligence database; all biometric element scores then being transmitted to the user's computing device; users then sharing all biometric element scores with other stakeholders; the user logging out; and the cloud network encrypting and archiving all events and transactions anonymously.

The computer system may be described in the general context of computer system executable instructions, such as program modules, being executed by a computer system. The app software is a non-transitory computer readable medium that includes computer-readable instructions that, when executed by a computer. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, system memory, and bus that couples various system components including system memory to processor. Processor may include software module that performs the methods described herein. The module may be programmed into the integrated circuits of processor, or loaded from memory, storage device, or network or combinations thereof. The Bus may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus. Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media. System memory can include computer system readable media in the form of volatile memory, such as random access memory (RAM) and/or cache memory or others. Computer system may further include other removable/non-removable volatile/non-volatile computer system storage media. By way of example only, storage devices can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 630 by one or more data media interfaces.

Computer system may also communicate with one or more external devices such as a keyboard, a pointing device, a display, etc; one or more devices that enable a user to interact with computer system; and/or any devices (e.g., network card, modem, etc.) that enable computer system to communicate with one or more other computing devices. Such communication can occur via Input/Output (I/O) interfaces. Still yet, computer system can communicate with one or more networks such as a local area network (LAN), a general wide area network (WAN), and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to some embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The computer program product may comprise all the respective features enabling the implementation of the methodology described herein, and which-when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A gamification system for teaching AI trustworthiness comprised of the following parts:
a) a software app for collecting biometric responses and providing an entertaining game; and
b) a cloud network for computing a trustworthiness score using artificial intelligence algorithms.

2. The gamification system for teaching AI trustworthiness of claim 1, wherein the software app is a non-transitory computer readable medium that includes computer-readable instructions that are executed by a computer.

3. The gamification system for teaching AI trustworthiness of claim 1, wherein the software app having operations to record respondent biometric element data on a user's mobile device such as: head movement; eye movement; mouth movement; eye blinking; pupil dilation; hand movement; fidgeting level; speech pitch; facial heat mapping, speech speed; micro expressions and filler word frequency.

4. The gamification system for teaching AI trustworthiness of claim 1, wherein the software app having operations to allow a user to perform a calibration whereby a user asks a respondent to sit still and answer a set of pre-determined questions which then become a baseline for a line of questioning event.

5. The gamification system for teaching AI trustworthiness of claim 1, wherein the software app having operations to allow pre-survey question guidance whereby the users pick from a range of related lines of questioning that they can choose from to replace existing questions with low confidence interval scores with those that have had higher confidence interval scores with respondents in the past.

6. The gamification system for teaching AI trustworthiness of claim 1, wherein the software app calculating the following scores from biometric element data: a trustworthiness score; a confidence interval; a suppression score; and an ambient conditions score.

7. The gamification system for teaching AI trustworthiness of claim 1, wherein the software app having operations to allow users to see a breakdown of trustworthiness and confidence interval scores of respondent answers for each question asked during a user's line of questioning.

8. The gamification system for teaching AI trustworthiness of claim 1, wherein the software app having a results dashboard that displays trustworthiness and confidence interval scores and suppression scores in real time as a line of questioning event is occurring to guide users.

9. The gamification system for teaching AI trustworthiness of claim 1, wherein the software app providing a respondent suppression score that detects when a respondent has recognized that they may be sending biometric signals that could be interpreted as untrustworthy and attempt to suppress them.

10. The gamification system for teaching AI trustworthiness of claim 1, wherein the software app having artificial intelligence algorithms to compare biometric element data collected during a line of questioning with a data base of other biometric element data in order to make recommendations for further questioning of a respondent.

11. A method for teaching AI trustworthiness comprised of the following steps:
a) providing the software app and cloud network of claim 1;
b) logging into the software app;
c) performing a line of questioning calibration (having respondent reading pre-determined questions while remaining still and recording all biometric elements as stated previously)
d) initiating a line of questioning event;
e) recording respondent's biometric elements onto a user's computing device;
f) transmitting biometric elements to the cloud network;
g) generating scores and comparing scores to database archives to make additional question recommendations using cloud network artificial intelligence algorithms;
h) adding gamification response data to artificial intelligence database;
i) transmitting biometric element scores to the user's computing device;
j) sharing biometric element scores with other stakeholders;
k) logging out; and
l) encrypting and archiving all events and transactions anonymously on the cloud network.
